(19) United States
(12) Patent Application Publication
(10) Pub. No.: US 2026/0018585 A1
(43) Pub. Date: Jan. 15, 2026

(54) APPARATUS AND METHOD FOR MANUFACTURING ELECTRODE PLATE OF SECONDARY BATTERY HAVING MULTIPLE COATING LAYERS

(71) Applicant: SAMSUNG SDI CO., LTD., Yongin-si (KR)

(72) Inventor: Hyunjin LEE, Yongin-si (KR)

(21) Appl. No.: 19/265,114

(22) Filed: Jul. 10, 2025

(30) Foreign Application Priority Data
Jul. 15, 2024 (KR) 10-2024-0093369

(51) Int. Cl. H01M 4/04; H01M 4/02; H01M 4/36

(52) U.S. Cl. CPC H01M 4/0404; H01M 4/0435; H01M 4/366; H01M 2004/021

(57) ABSTRACT

An apparatus for manufacturing an electrode plate of a secondary battery includes a lower-layer coater configured to coat a substrate of the secondary battery with a lower layer, a lower-layer roller configured to roll the lower layer coated on the substrate, an upper-layer coater configured to coat an upper layer on the lower layer rolled on the substrate, and an upper-layer roller configured to roll the upper layer on the lower layer, the upper-layer roller being configured to roll the upper layer at a mixture density lower than a mixture density of the lower layer rolled by the lower-layer roller.

### CROSS-REFERENCE TO RELATED APPLICATION

The present application claims priority to and the benefit of Korean Patent Application No. 10-2024-0093369, filed on Jul. 15, 2024, in the Korean Intellectual Property Office, the entire disclosure of which is incorporated herein by reference.

### BACKGROUND

### 1. Field

The present disclosure relates to an apparatus and method for manufacturing an electrode plate of a secondary battery. More specifically, the present disclosure relates to an apparatus and method for manufacturing an electrode plate having multiple coating layers.

### 2. Description of the Related Art

Secondary batteries are batteries that can be (re) charged or discharged, unlike primary batteries that cannot be recharged. Generally, secondary batteries may include an electrode assembly having positive/negative electrode plates and a separator. The positive/negative electrode plates may be manufactured by processes such as rolling, drying, slitting, notching, etc., following a process of coating a substrate with an active material. The positive/negative electrode plates manufactured in this manner may be disposed with a separator interposed therebetween, and the electrode assembly may be completed using a winding method or a stacking method.

The coating process is a process of coating one or both sides of positive and negative electrode substrates with an active material mixture (slurry or powder). In the rolling process, a substrate coated with the active material mixture is pressed and stretched by a roller to make it thin and flat, thereby improving density and increasing a bonding strength between a surface and an active material, as well as allowing lithium ions to move smoothly to increase the output power and performance of the secondary battery.

The above information disclosed in this Background section is for enhancement of understanding of the background of the present disclosure, and therefore, it may contain information that does not constitute related (or prior) art.

### SUMMARY

According to an aspect of the present disclosure, there is provided an apparatus for manufacturing an electrode plate of a secondary battery, which includes a lower-layer coater configured to perform coating a substrate of the secondary battery with a lower layer, a lower-layer roller configured to roll the applied lower layer, an upper-layer coater configured to perform coating the rolled lower layer with an upper layer, and an upper-layer roller configured to roll the applied upper layer, wherein the upper-layer roller rolls the applied upper layer at a mixture density lower than a mixture density of the lower layer rolled by the lower-layer roller.

According to another aspect of the present disclosure, there is provided a method of manufacturing an electrode plate of a secondary battery, which includes a lower-layer coating operation of coating a substrate of the secondary battery with a lower layer, a lower-layer rolling operation of rolling the applied lower layer, an upper-layer coating operation of coating the rolled lower layer with an upper layer, and an upper-layer rolling operation of rolling the applied upper layer, wherein the applied upper layer is rolled at a mixture density lower than a mixture density of the lower layer rolled in the lower-layer rolling operation.

According to still another aspect of the present disclosure, there is provided an electrode plate of a secondary battery, which includes a lower layer with which a substrate of the secondary battery is coated, and an upper layer with which the lower layer is coated, wherein a mixture density of the upper layer is lower than a mixture density of the lower layer.

According to some embodiments, the mixture density of the rolled lower layer may range from 1.0 to 2.0 g/cc, and the mixture density of the rolled upper layer may be 50 to 90% of the mixture density of the lower layer.

Features and aspects of the present disclosure is not limited to the above, and other features and aspects not specifically mentioned herein, and aspects of the present disclosure that would address such problems, will be clearly understood by those skilled in the art from the description of the present disclosure below.

### BRIEF DESCRIPTION OF THE DRAWINGS

Features will become apparent to those of skill in the art by describing in detail exemplary embodiments with reference to the attached drawings, in which:

FIG. 1 schematically illustrates an electrode assembly manufactured using an electrode plate manufactured by a method/apparatus for manufacturing an electrode plate of a secondary battery according to the present disclosure;

FIG. 2 schematically illustrates a pouch-type secondary battery in which the electrode assembly manufactured using the electrode plate manufactured by the method/apparatus for manufacturing the electrode plate of the secondary battery according to the present disclosure is implemented;

FIG. 3 is a cross-sectional view of a cylindrical secondary battery in which the electrode assembly manufactured using the electrode plate manufactured by the method/apparatus for manufacturing the electrode plate of the secondary battery according to the present disclosure is implemented;

FIG. 4 is a view of an internal configuration of a prismatic secondary battery in which the electrode assembly manufactured using the electrode plate manufactured by the method/apparatus for manufacturing the electrode plate of the secondary battery according to the present disclosure is implemented;

FIG. 5 is a schematic view for describing an entire process of manufacturing an electrode plate according to the present disclosure;

FIG. 6 is a schematic plan view of a coated substrate in FIG. 5;

FIG. 7A is a cross-sectional view of an electrode plate in which a mixture layer is formed in two layers on one side of a substrate;

FIG. 7B is a cross-sectional view of an electrode plate in which a mixture layer is formed in two layers on both sides of a substrate;

FIG. 8A is a schematic view of a single-sided electrode plate according to some embodiments of the present disclosure;

FIG. 8B illustrates a process of forming a coating layer having two layers of lower and upper layers on one side of a substrate;

FIG. 8C illustrates an example of an apparatus that performs the process of FIG. 8B using one coater and one roller in common;

FIG. 8D illustrates another example of the apparatus that performs the process of FIG. 8B;

FIG. 9A is a schematic view of a double-sided electrode plate according to some other embodiments of the present disclosure;

FIG. 9B illustrates a process of forming a coating layer having two layers of lower and upper layers on each of both sides of a substrate;

FIG. 9C illustrates an example of an apparatus that performs the process of FIG. 9B using one side-A coater, one side-B coater, and one roller in common;

FIG. 9D illustrates another example of the apparatus that performs the process of FIG. 9B;

FIG. 10A is a schematic view of a single-sided electrode plate according to some other embodiments of the present disclosure;

FIG. 10B illustrates a process of forming a coating layer having three layers of a lower layer, an intermediate layer, and an upper layer on one side of a substrate;

FIG. 10C illustrates an example of an apparatus that performs the process of FIG. 10B using one coater and one roller in common; and

FIG. 10D illustrates another example of the apparatus that performs the process of FIG. 10B.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. Terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms.

The embodiments described in this specification and the configurations shown in the drawings are only some of one or more embodiments of the present disclosure and do not represent all of the aspects of the present disclosure. Accordingly, it should be understood that there may be various equivalents and modifications that can replace or modify one or more embodiments described herein at the time of filing this application.

It will be understood that if an element or layer is referred to as being “on,” “connected to,” “coupled to,” or “linked to” another element or layer, or “between” two elements or layers, it may be directly on, connected, coupled or linked to the other element or layer (or directly between two elements or layers) or one or more intervening elements or layers may also be present. When an element or layer is referred to as being “directly on,” “directly connected to,” or “directly coupled to” another element or layer (or “directly between”), there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements throughout. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C,” “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

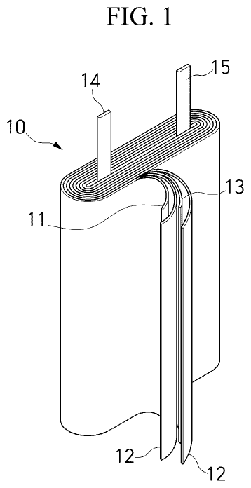

FIG. 1 schematically illustrates an electrode assembly manufactured using an electrode plate manufactured by a method/apparatus for manufacturing an electrode plate of a secondary battery according to the present disclosure.

Referring to FIG. 1, an electrode assembly 10 may be formed by winding or stacking a stack of a first electrode plate 11, a separator 12, and a second electrode plate 13, which are formed as thin plates or films. When the electrode assembly 10 is a wound stack, a winding axis may be parallel to the longitudinal direction of the case. In other embodiments, the electrode assembly 10 may be a stack type rather than a winding type. In addition, the electrode assembly 10 may be a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case. The first electrode plate 11 of the electrode assembly may act as a negative electrode, and the second electrode plate 13 may act as a positive electrode, e.g., the reverse is also possible.

The first electrode plate 11 may be formed by applying a first electrode active material, such as graphite or carbon, to a first electrode current collector formed of a metal foil, such as copper, a copper alloy, nickel, or a nickel alloy. A first electrode tab 14 may be connected to an external first terminal. In some embodiments, when the first electrode plate 11 is manufactured, the first electrode tab 14 may be formed by being cut in advance to protrude to one side of the electrode assembly 10, or the first electrode tab 14 may protrude to one side of the electrode assembly 10 more than (e.g., farther than or beyond) the separator 12 without being separately cut.

The second electrode plate 13 may be formed by applying a second electrode active material, such as a transition metal oxide, on a second electrode current collector formed of a metal foil, such as aluminum or an aluminum alloy. The second electrode plate 13 may include a second electrode tab 15 (e.g., a second uncoated portion) that is a region to which the second electrode active material is not applied. The second electrode tab 15 may be connected to an external second terminal. In some embodiments, the second electrode tab 15 may be formed by being cut in advance to protrude to the other side (e.g., the opposite side) of the electrode assembly 10 when the second electrode plate 13 is manufactured, or the second electrode plate 13 may protrude to the other side of the electrode assembly more than (e.g., farther than or beyond) the separator 12 without being separately cut.

In some embodiments, the first electrode tab 14 may be located on the left side of the electrode assembly 10, and the second electrode tab 15 may be located on the right side of the electrode assembly 10. In other embodiments, the first electrode tab 14 and the second electrode tab 15 may be located on one side of the electrode assembly 10 in the same direction. Here, for convenience of description, the left and right sides are defined according to the electrode assembly 10 as oriented in FIG. 1, and the positions thereof may change when the secondary battery is rotated left and right or up and down.

The separator 12 prevents a short-circuit between the first electrode plate 11 and the second electrode plate 13 while allowing movement of lithium ions therebetween. The separator 12 may be made of, e.g., a polyethylene film, a polypropylene film, a polyethylene-polypropylene film, or the like.

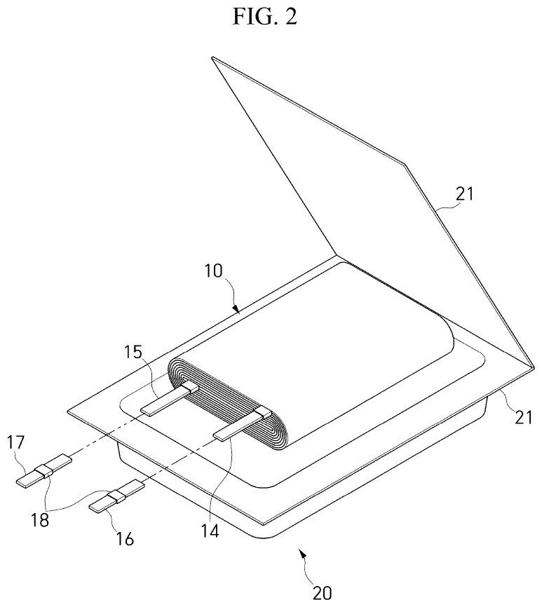

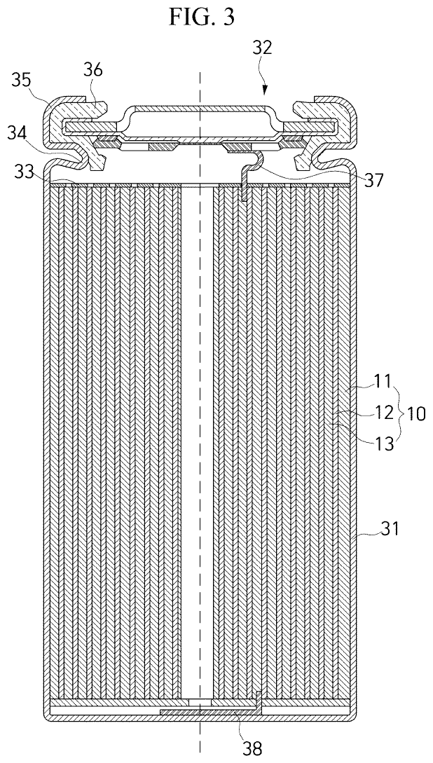

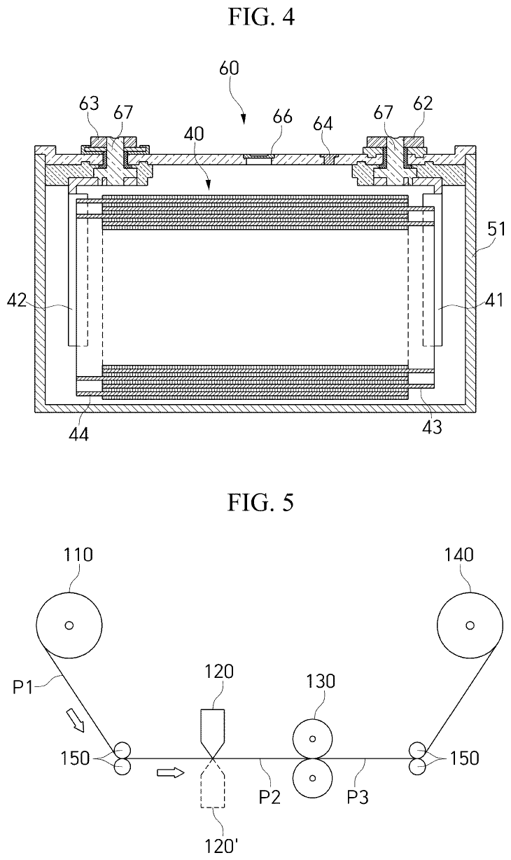

In some embodiments, the electrode assembly 10 may be accommodated in the case along with an electrolyte. In the case of a pouch-type secondary battery, the electrode assembly 10 may be accommodated in a pouch made of flexible material in the form illustrated in FIG. 2. In the case of a cylindrical or prismatic secondary battery, an electrode assembly may be accommodated in a cylindrical or prismatic metal casing in the form illustrated in FIGS. 3 and 4.

Hereinafter, any suitable material that may be usable for the secondary battery according to the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel oxide, a lithium cobalt oxide, a lithium manganese oxide, a lithium iron phosphate compound, a cobalt-free nickel-manganese oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X₆O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001<b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g<0.5); Li_{(3-f)}Fe₂(PO₄)₃ (0≤f≤2); and LiₐFePO₄ (0.90≤a≤1.8).

In the above formulas: A may be Ni, Co, Mn, or a combination thereof; X may be Al, Ni, Co, Mn, Cr, Fe, Mg, Sr, V, a rare earth element, or a combination thereof; D may be O, F, S, P, or a combination thereof; G may be Al, Cr, Mn, Fe, Mg, La, Ce, Sr, V, or a combination thereof; and L1 may be Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material may be in a range of about 90 wt % to about 99.5 wt % on the basis of 100 wt % of the positive electrode active material layer, and the content of the binder and the conductive material may be in a range of about 0.5 wt % to about 5 wt %, respectively, on the basis of 100 wt % of the positive electrode active material layer.

The current collector may be aluminum (Al).

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon negative electrode active material, which may include, e.g., crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si negative electrode active material or a Sn negative electrode active material may be used as the material capable of being doped and undoped with lithium. The Si negative electrode active material may be silicon, a silicon-carbon composite, SiOₓ (0<x<2), a Si alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate, an ester, an ether, a ketone, an alcohol solvent, an aprotic solvent, and may be used alone or in combination of two or more.

In addition, when a carbonate solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

FIG. 2 schematically illustrates a pouch-type secondary battery to which the electrode assembly manufactured using the electrode plate manufactured by the method/apparatus for manufacturing the electrode plate of the secondary battery according to the present disclosure may be implemented.

Referring to FIG. 2, the pouch-type secondary battery includes an electrode assembly 10 and a pouch 20 that accommodates the electrode assembly 10 of FIG. 1. The first electrode tab 14 and the second electrode tab 15 of the electrode assembly 10 may be electrically connected to respective external first and second terminal leads 16 and 17 by welding. Each of the first terminal lead 16 and the second terminal lead 17 may be attached with a tab film 18 for insulation from the pouch 20.

The pouch 20 may be sealed by having sealing parts 21 at the edges thereof come into contact with each other with accommodating the electrode assembly 10 therein, in which case the sealing may be achieved with the tab film 18 interposed between the sealing parts 21. The sealing parts 21 of the pouch 20 may each be made of a thermal fusion material that generally has weak adhesion to metal. Thus, it may be fused to the pouch 20 by interposing the thin tab film 18 between the sealing parts 21.

FIG. 3 is a cross-sectional view of a cylindrical secondary battery to which the electrode assembly manufactured using the electrode plate manufactured by the method/apparatus for manufacturing the electrode plate of the secondary battery according to the present disclosure may be implemented.

Referring to FIG. 3, the cylindrical secondary battery may include the electrode assembly 10, a case 31 accommodating the electrode assembly 10 and an electrolyte therein, a cap assembly 32 coupled to an opening of the case 31 to seal the case 31, and an insulating plate 33 positioned between the electrode assembly 10 and the cap assembly 32 inside the case 31.

The case 31 may accommodate the electrode assembly 10 and the electrolyte, and, together with the cap assembly 32, may form the external appearance of the secondary battery. The case 31 may have a substantially cylindrical body portion and a bottom portion connected to one side (e.g., to one end) of the body portion. A beading part 34 (e.g., a bead) deformed inwardly may be formed in the body portion, and a crimping part 35 (e.g., a crimp) bent inwardly may be formed at an open end of the body portion.

The beading part 34 can reduce or prevent movement of the electrode assembly 10 inside the case 31 and can facilitate seating of the gasket and the cap assembly 32. The crimping part 35 may firmly fix the cap assembly 32 by pressing the edge of the case 31 against a gasket 36. The case 31 may be formed of, e.g., iron plated with nickel.

The cap assembly 32 may be fixed to the inside of the crimping part 35 by the gasket 36 to seal the case 31. A first lead tab 37 drawn out from the electrode assembly 10 may be connected to the cap assembly 32, and a second lead tab 38 drawn out from the electrode assembly 10 may be electrically connected to the bottom of the case 31.

FIG. 4 is a view of an internal configuration of a prismatic secondary battery to which the electrode assembly manufactured using the electrode plate manufactured by the method/apparatus for manufacturing the electrode plate of the secondary battery according to the present disclosure may be implemented.

As shown in FIG. 4, a prismatic secondary battery may include an electrode assembly 40, a first current collector 41, a first terminal 62, a second current collector 42, a second terminal 63, a case 51, and a cap assembly 60.

The electrode assembly 40 may be formed by winding or stacking a stack of a first electrode plate, a separator, and a second electrode plate, which are formed as thin plates or films. When the electrode assembly 40 is a wound stack, a winding axis may be parallel to the longitudinal direction of the case 51. In other embodiments, the electrode assembly 40 may be a stack type rather than a winding type. In addition, the electrode assembly 40 may be a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case. The first electrode plate of the electrode assembly may act as a negative electrode, and the second electrode plate may act as a positive electrode, e.g., the reverse is also possible.

In the electrode assembly 40, the first current collector 41 and the second current collector 42 may be welded and connected to the first electrode tab 43 extending from the first electrode plate and the second electrode tab 44 extending from the second electrode plate, respectively. As mentioned above, in some embodiments in which the first electrode tab 43 and the second electrode tab 44 are located at the top of the electrode assembly 40, the first and second current collectors 41 and 42 may be located at the top of the electrode assembly 40.

As illustrated in FIG. 4, the first current collector 41 and the second current collector 42 may be connected to the first terminal 62 and the second terminal 63 through connection members 67, respectively. For example, the connection members 67 may each have an outer peripheral surface that is threaded, and may be fastened to the first terminal 62 and the second terminal 63 by screwing. In another example, the connection members 67 may also be coupled to the first terminal 62 and the second terminal 63 by riveting or welding.

FIG. 5 is a schematic view for describing an entire process of manufacturing an electrode plate (i.e., a first electrode plate 11 or a second electrode plate 13).

Referring to FIG. 5, a supply roll 110 may be a roll on which a substrate P1 for an electrode plate is wound. For example, when an apparatus for manufacturing electrode plates according to the present disclosure is used to manufacture a positive electrode plate, the substrate P1 may be a metal foil containing aluminum (Al). In another example, when the apparatus for manufacturing electrode plates according to the present disclosure is used to manufacture a negative electrode plate, the substrate P1 may be a metal foil containing copper (Cu) or nickel (Ni).

For example, a transfer roller 150 may be an idle roller that guides the substrate P1 in an unwound state from the supply roll 110. In another example, the transfer roller 150 may be a drive roller that applies a pulling force to unwound the substrate P1 from the supply roll 110. FIG. 5 illustrates a total of four transfer rollers 150 as an example only, and the number and positions of transfer rollers may be changed as needed.

A coater 120 may form a coating layer by coating the substrate P1 with an electrode material slurry that is previously prepared to form a coated substrate P2.

Here, the coating layer may include a coating mixture including an active material. For example, when the apparatus for manufacturing the electrode plate according to the present disclosure is used to manufacture a positive electrode plate, the coating mixture may include an active material including a lithium transition metal oxide, a binder, and a volatile solvent. In another example, when the apparatus for manufacturing the electrode plate according to the present disclosure is used to manufacture a negative electrode plate, the coating mixture may include an active material, a binder, and a solvent. Referring to FIG. 5, both surfaces (e.g., opposite surfaces) of the substrate P1 (e.g., the upper and lower surfaces of the substrate P1) may be coated simultaneously by adding a second coater 120′ to face the lower surface of the substrate P1 (e.g., the coater 120 and second coater 120′ may face each other with the substrate P1 arranged therebetween).

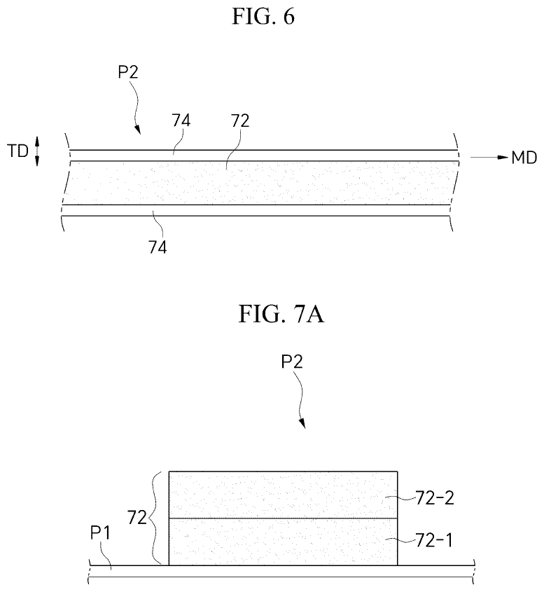

For example, as illustrated in FIG. 6, the coated substrate P2 may have a coated portion coated with the active material mixture (i.e., coated with a mixture layer 72), and an uncoated portion 74 on which coating is not performed and which is left without change. For reference, hereinafter, a width direction of the electrode plate is referred to as a transverse direction TD, and a longitudinal direction, which is a direction in which the electrode plate moves, is referred to as a machine direction MD. In another example, there may be also a multi-row coating method in which coating areas in multiple rows are simultaneously coated in the width direction (i.e., TD) of a substrate. After a substrate coated in the multi-row coating method goes through a rolling process, the coated substrate may be cut in a longitudinal direction (i.e., MD) in the slitting process to be separated into electrode plates for each row.

Referring back to FIG. 5, a press unit (e.g., a roller 130) may use a rolling roller to compress the coated substrate P2 coated with the slurry (mixture) by the coater 120 in order to produce a high-capacity and high-density secondary battery, e.g., to produce an electrode plate P3.

The rolling process is a process for increasing the capacity of a battery by reducing a thickness of an electrode plate to increase a density of an electrode, improving a contact strength between a substrate and an active material, and generating directionality in a crystal structure of the active material to facilitate the entry and exit of lithium ions. The density of the electrode is determined through the rolling process, and is referred to as a mixture density. When the mixture density is too high, an electrolytic solution may not penetrate well into cells.

As further illustrated in FIG. 5, a winding roll 140 (e.g., a winder) may be a roll that winds and accommodates the electrode plate P3 coated and rolled by the coater 120 and the roller 130.

A double layer electrode (DLE) method in the coating process refers to a method of forming two or more mixture layers on a same surface of a substrate.

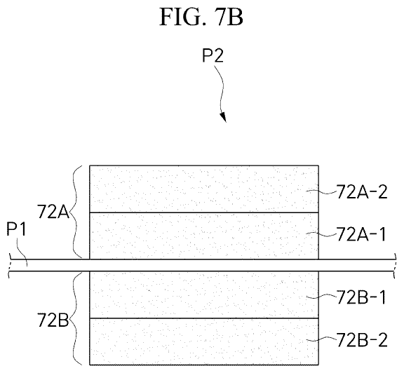

In the case of a single-sided electrode plate illustrated in FIG. 7A, it can be seen that the mixture layer 72, with which the substrate P1 is coated, may include two layers of a lower layer 72-1 and an upper layer 72-2. Further, in the case of a double-sided electrode plate illustrated in FIG. 7B, a mixture layer 72A, with which an upper side (hereinafter, referred to as a “side A”) of the substrate P1 is coated, may include two layers of a lower layer 72A-1 and an upper layer 72A-2, and a mixture layer 72B, with which a lower side (hereinafter, referred to as a “side B”) of the substrate P1 is coated, may include a lower layer 72B-1 and an upper layer 72B-2, such that the mixture layers 72A and 72B may be formed symmetrically on sides A and B on the coated substrate P2.

When DLE electrode plates are manufactured by coating both sides of a substrate with both lower and upper layers as illustrated in FIGS. 7A and 7B, followed by simultaneously rolling all mixture layers to have same mixture densities, ionic resistance may increase as the overall mixture density increases. As such, cell performance may be degraded, e.g., such a phenomenon may be more severe in the case of the negative electrode.

In contrast, the present disclosure provides a new process for allowing a lower coating layer (hereinafter, referred to as a “lower layer”) and an upper coating layer (hereinafter, referred to as an “upper layer”) in the DLE electrode plate to have different mixture densities. To this end, the processes of lower layer coating-lower layer rolling-upper layer coating-upper layer rolling may be performed such that the upper layer rolling may be performed so that the mixture density during the upper layer rolling is lower than the mixture density during the lower layer rolling.

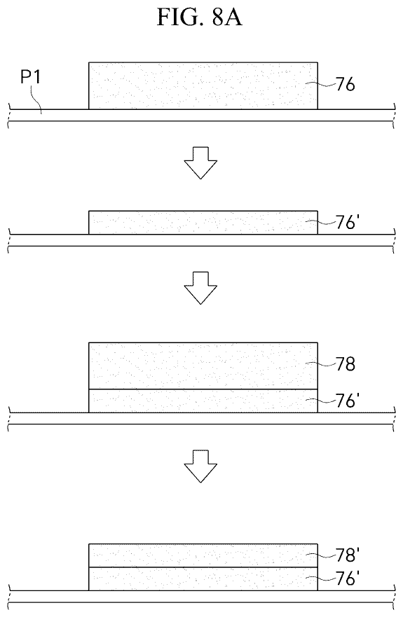

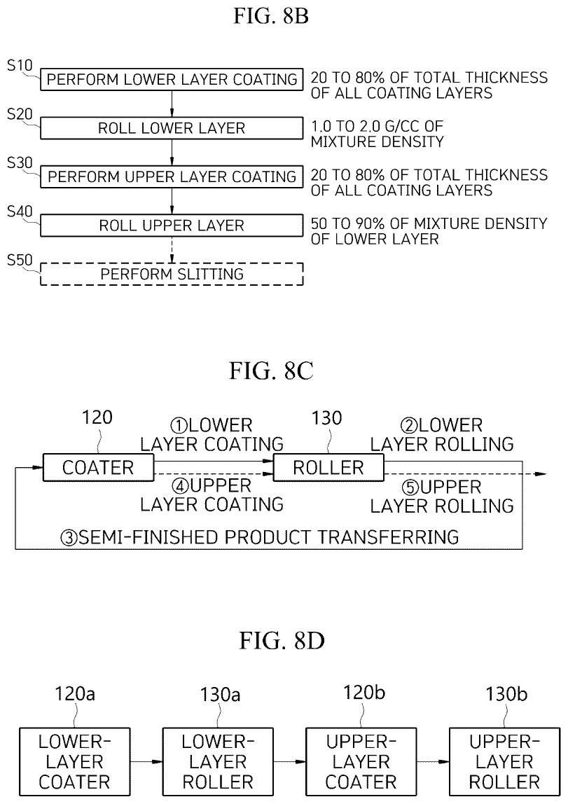

FIG. 8A is a schematic view of a single-sided electrode plate according to some embodiments of the present disclosure. FIG. 8B illustrates a process of forming a coating layer having two layers of lower and upper layers on one side of the substrate P1 according to the embodiments.

Referring to FIGS. 8A and 8B, the substrate P1 may be coated with a lower layer 76 (S10). A thickness of the lower layer 76 may be about 20% to about 80% of a total thickness of all coating layers (lower layer+upper layer) to be formed by coating, e.g., a thickness of the lower layer 76, before rolling, may be about 20% to about 80% of a total thickness of all coating layers before rolling.

The lower layer 76 may be rolled into a rolled lower layer 76′ (S20), e.g., to have a smaller thickness than the lower layer 76. In this case, a mixture density of the rolled lower layer 76′ may be about 1.0 to 2.0 g/cc.

The rolled lower layer 76′ may be coated with an upper layer 78 (S30). A thickness of the upper layer 78 may be about 20% to about 80% of the total thickness of all the coating layers.

The upper layer 78 may be rolled into a rolled upper layer 78′ (S40), e.g., to have a smaller thickness than the upper layer 78. In this case, a mixture density of the rolled upper layer 78′ may be about 50% to about 90% of the mixture density of the rolled lower layer 76′ described above, e.g., the rolled lower and upper layers 76′ and 78′ may be rolled for different lengths of time and/or different pressures to provide different mixture densities.

In the case of multi-row coating, the substrate P1 may be separated into a plurality of electrode plates by slitting.

FIG. 8C illustrates a schematic apparatus that performs the process of FIG. 8B, and illustrates an example of the apparatus that performs the process of FIG. 8B using one coater 120 and one roller 130 in common.

Referring to FIGS. 8A-8C, \textcircled{1} the coater 120 may perform coating of the lower layer 76. \textcircled{2} The lower layer 76 may be rolled using the roller 130. \textcircled{3} A semi-finished electrode plate which is coated with the lower layer 76 and rolled may be transferred back to the coater 120. \textcircled{4} The coater 120 may perform coating of the upper layer 78. \textcircled{5} The upper layer 78 may be rolled using the roller 130. For example, referring to FIG. 8C, the process may include an additional transfer path (e.g., a conveyor) to transfer the rolled lower layer 76 from the roller 130 back to the coater 120.

FIG. 8D illustrates another example of a schematic apparatus that performs the process of FIG. 8B, in which a dedicated coater and a dedicated roller are used for each of the lower layer and the upper layer (e.g., an additional coater and an additional roller may be arranged).

For example, referring to FIG. 8D, the apparatus for coating and rolling the electrode plate according to the embodiments may include a lower-layer coater 120a that performs coating of the lower layer 76, a lower-layer roller 130a that rolls the lower layer 76, an upper-layer coater 120b that performs coating of the upper layer 78, and an upper-layer roller 130b that rolls the upper layer 78. For example, referring to FIG. 8D, the lower-layer coater 120a, the lower-layer roller 130a, the upper-layer coater 120b, and the upper-layer roller 130b may be arranged sequentially.

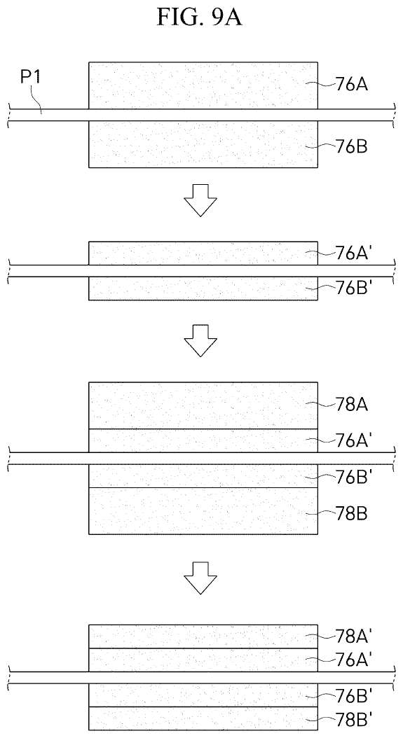

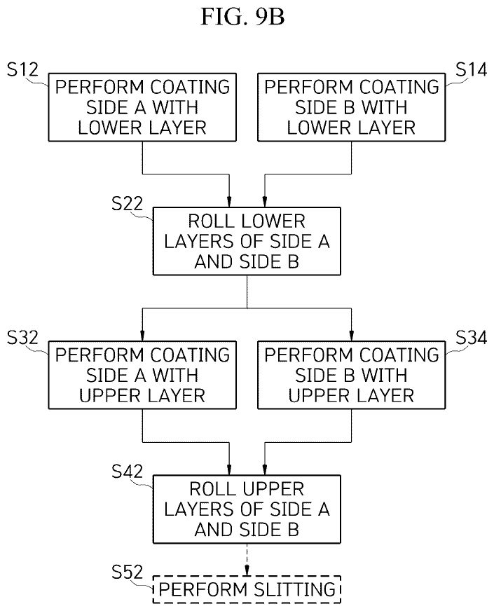

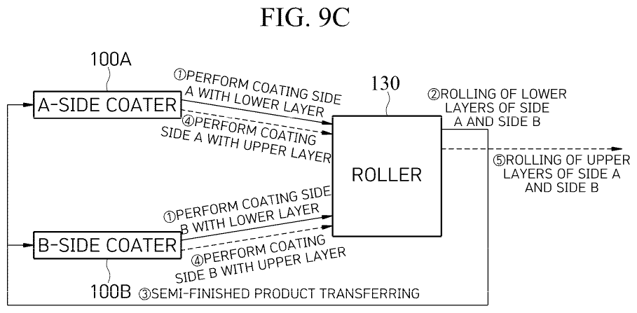

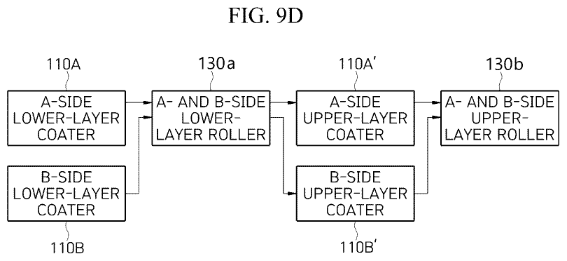

FIG. 9A is a schematic view of a double-sided electrode plate according to some other embodiments of the present disclosure. FIG. 9B illustrates a process of forming a coating layer having two layers of lower and upper layers on each of both sides of a substrate P1 according to the embodiments.

Referring to FIGS. 9A and 9B, a side A of the substrate P1 may be coated with the lower layer 76A (S12). A thickness of the lower layer 76A may be about 20% to about 80% of a total thickness of the all coating layers (lower layer+upper layer) to be formed by coating.

A side B of the substrate P1 may be coated with the lower layer 76B (S14). A thickness of the lower layer 76B may be about 20% to about 80% of the total thickness of the all coating layers (lower layer+upper layer) to be formed by coating.

The lower layers 76A and 76B, with which the side A and the side B are coated, may be rolled into of rolled lower layers 76A′ and 76B′, respectively (S22). In this case, a mixture density of each of the rolled lower layers 76A′ and 76B′ may be about 1.0 g/cc to 2.0 g/cc.

The side A of the substrate P1 may be coated with an upper layer 78A (S32). A thickness of the upper layer 78A may be about 20% to about 80% of the total thickness of the all coating layers.

The side B of the substrate P1 may be coated with an upper layer 78B (S34). A thickness of the upper layer 78B may be about 20% to about 80% of the total thickness of the all coating layers.

The upper layers 78A and 78B, with which the side A and the side B are coated, may be rolled into rolled upper layers 78A′ and 78B′, respectively (S42). In this case, a mixture density of each of the rolled upper layers 78A′ and 78B′ may be about 50% to 90% of the mixture density of each of the rolled lower layers 76A′ and 76B′ described above.

In the case of multi-row coating, the substrate P1 may be separated into a plurality of electrode plates by slitting (S52).

FIG. 9C illustrates an apparatus that performs the process of FIG. 9B, and illustrates an example of the apparatus that performs the process of FIG. 9B using one side-A coater 100A, one side-B coater 100B, and one roller 130 in common.

Referring to FIGS. 9A-9C, \textcircled{1}) the side-A coater 100A may coat the side A with the lower layer 76A and the side-B coater 100B may coat the side B with the lower layer 76B. \textcircled{2} The lower layers 76A and 76B, with which the side A and the side B are coated, may be rolled, e.g., simultaneously, using the same roller 130. \textcircled{3} A semi-finished electrode plate of which the side A and the side B are coated with the lower layers 76A and 76B and which are rolled may be transferred back to each of the side-A coater 100A and the side-B coater 100B. \textcircled{4} The side-A coater 100A may coat the upper layer 78A on the side A and the side-B coater 100B may coat the side B with the upper layer 78B. \textcircled{5} The upper layers 78A and 78B, with which the side A and the side B are coated, may be rolled using the roller 200.

FIG. 9D illustrates another example of the apparatus that performs the process of FIG. 9B, in which a dedicated coater and a dedicated roller are used for each of the lower layers and the upper layers.

Referring to FIG. 9D, the apparatus for coating and rolling the electrode plate according to the embodiments may include the side-A lower-layer coater 110A that performs coating on the side A with the lower layer 76A, the side-B lower-layer coater 110B that performs coating on the side B with the lower layer 76B, a side A-and-B lower-layer roller 130a that rolls the lower layers 76A and 76B with which the side A and the side B are coated, a side-A upper-layer coater 110A′ that performs coating on the side A with the upper layer 78A, a side-B upper-layer coater 110B′ that performs coating on the side B with the upper layer 78B, and a side A-and-B upper-layer roller 130b that rolls the upper layers 78A and 78B with which the side A and the side B are coated.

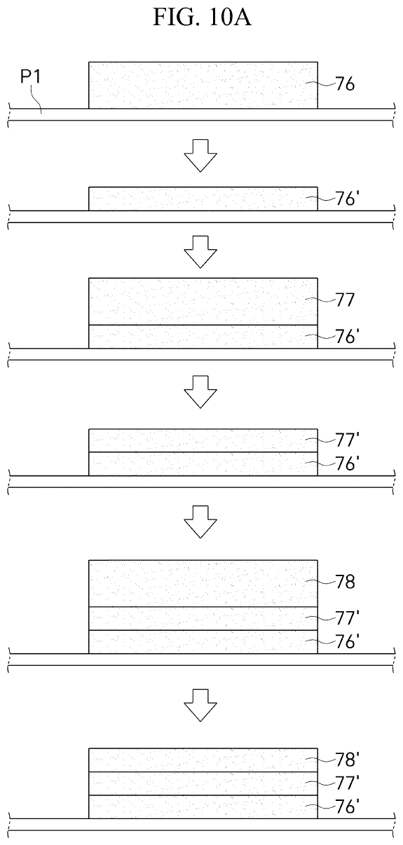

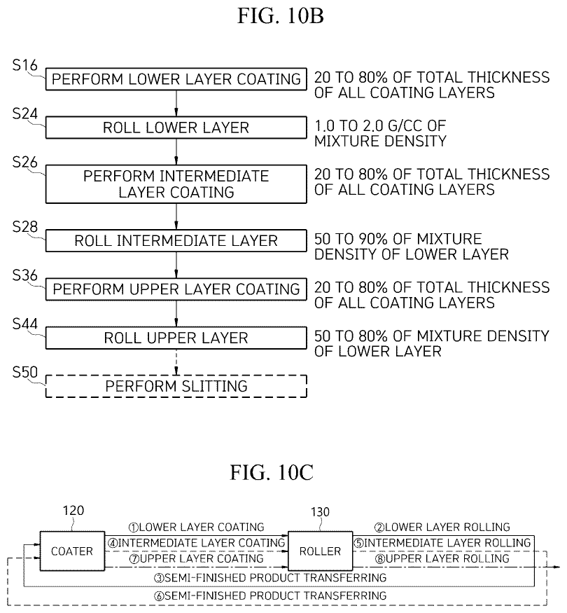

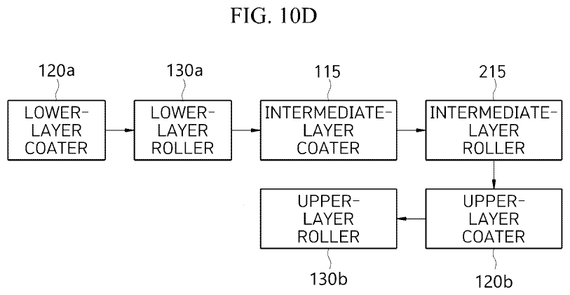

FIG. 10A is a schematic view of a single-sided electrode plate according to some other embodiments of the present disclosure, and illustrates an electrode plate in which a coating layer having three layers of a lower layer, an intermediate layer, and an upper layer is formed on one side of the substrate P1. FIG. 10B illustrates a process of forming a coating layer having three layers of a lower layer, an intermediate layer, and an upper layer on one side of the substrate P1 according to the embodiments.

Referring to FIGS. 10A-10B, the substrate P1 may be coated with a lower layer 76 (S16). A thickness of the lower layer 76 may be about 20% to about 80% of a total thickness of the all three coating layers (lower layer+intermediate layer+upper layer) to be formed by coating.

The lower layer 76 may be rolled (S24). In this case, a mixture density of the rolled lower layer 76′ may be about 1.0 g/cc to 2.0 g/cc.

The rolled lower layer 76 may be coated with an intermediate layer 77 (S26). A thickness of the intermediate layer 77 may be about 20% to about 80% of the total thickness of the all coating layers.

The intermediate layer 77 may be rolled (S28). In this case, a mixture density of a rolled intermediate layer 77′ may be about 50% to about 90% of the mixture density of the rolled lower layer 76′ described above.

The rolled intermediate layer 77 may be coated with an upper layer 78 (S36). A thickness of the upper layer 78 may be about 20% to about 80% of the total thickness of the all coating layers.

The upper layer 78 may be rolled (S44). In this case, a mixture density of the rolled upper layer 78′ may be about 50% to about 80% of the mixture density of the rolled lower layer 76′ described above.

In the case of multi-row coating, the substrate P1 may be separated into a plurality of electrode plates by slitting (S50).

FIG. 10C illustrates an apparatus that performs the process of FIG. 10B, and illustrates an example of the apparatus that performs the process of FIG. 10B using one coater 120 and one roller 130 in common.

Referring to FIGS. 10A-10C, \textcircled{1} the coater 120 may perform coating with the lower layer 76. \textcircled{2} The lower layer 76 may be rolled using the roller 130. \textcircled{3} A semi-finished electrode plate which is coated with the lower layer 76 and rolled may be transferred back to the coater 100. \textcircled{4} The coater 120 may perform coating with the intermediate layer 77. \textcircled{5} The intermediate layer 77 may be rolled using the roller 130. \textcircled{6} A semi-finished electrode plate which is coated with the intermediate layer 77 and rolled may be transferred back to the coater 100. \textcircled{7} The coater 120 may perform coating with the upper layer 78. \textcircled{8} The upper layer 78 is rolled using the roller 130.

FIG. 10D illustrates another example of the apparatus that performs the process of FIG. 10B, in which a dedicated coater and a dedicated roller are used for each of a lower layer 76, an intermediate layer 77, and an upper layer 78.

Referring to FIG. 10D, the apparatus for coating and rolling the electrode plate according to the embodiments may include a lower-layer coater 120a that performs coating with the lower layer 76, a lower-layer roller 130a that rolls the lower layer 76, an intermediate-layer coater 115 that performs coating with the intermediate layer 77, an intermediate-layer roller 215 that rolls the intermediate layer 77, an upper-layer coater 120b that performs coating with the upper layer 78, and an upper-layer roller 130b that rolls the upper layer 78.

Although an electrode plate in which a total of three layers (i.e., the lower layer 76, the intermediate layer 77, and the upper layer 78) are formed on only one side of the substrate is described with reference to FIGS. 10A to 10C, the three coating layers may be formed on both sides of the substrate. Further, an electrode plate may be formed with more than three layers on one or two surfaces thereof.

By way of summation and review, a double layer electrode (DLE) method in the coating process is a method in which two or more layers of a mixture layer (coating layer) are formed on a substrate and rolled to increase energy density. However, as a mixture density increases when a DLE electrode plate is rolled, ionic resistance increases and thus cell performance may degrade.

In contrast, the present disclosure is directed to increasing energy density, which is an advantage of the DLE, without degrading the cell performance, by improving a process of manufacturing a DLE electrode plate so as not to increase ionic resistance. That is, according to the present disclosure, since a mixture density of an upper layer of an electrode plate is lower than that of a lower layer of the electrode plate, it is possible to reduce ionic resistance to improve the cell lifetime and rapid charging speed, and maintain an effect of increasing energy density, which is an inherent advantage of DLE.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An apparatus for manufacturing an electrode plate of a secondary battery, the apparatus comprising:
a lower-layer coater configured to coat a substrate of the secondary battery with a lower layer;
a lower-layer roller configured to roll the lower layer coated on the substrate;
an upper-layer coater configured to coat an upper layer on the lower layer rolled on the substrate; and
an upper-layer roller configured to roll the upper layer on the lower layer, the upper-layer roller being configured to roll the upper layer to a mixture density lower than a mixture density of the lower layer rolled by the lower-layer roller.

2. The apparatus as claimed in claim 1, wherein:
a thickness of the lower layer coated on the substrate is 20% to 80% of a sum of thicknesses of the lower layer and the upper layer, and
a thickness of the upper layer coated on the lower layer is 20% to 80% of the sum of the thicknesses of the lower layer and the upper layer.

3. The apparatus as claimed in claim 1, wherein:
the mixture density of the lower layer ranges from 1.0 to 2.0 g/cc, and
the mixture density of the upper layer is 50% to 90% of the mixture density of the lower layer.

4. The apparatus as claimed in claim 1, wherein:
the lower-layer coater and the upper-layer coater are a same coater; and
the lower-layer roller and the upper-layer roller are a same roller.

5. The apparatus as claimed in claim 1, wherein:
the lower-layer coater includes a first-side lower-layer coater that coats a first side of the substrate with the lower layer, and a second-side lower-layer coater that coats a second side of the substrate with the lower layer, and
the upper-layer coater includes a first-side upper-layer coater that coats the first side of the substrate with the upper layer, and a second-side upper-layer coater that coats the second side of the substrate with the upper layer.

6. The apparatus as claimed in claim 1, further comprising:
an intermediate-layer coater configured to coats an intermediate layer on the lower layer rolled by the lower-layer roller; and
an intermediate-layer roller configured to roll the intermediate layer, the intermediate-layer roller being configured to roll the intermediate layer to a mixture density lower than the mixture density of the lower layer rolled by the lower-layer roller.

7. The apparatus as claimed in claim 6, wherein a thickness of the intermediate layer coated on the lower layer is 20% to 80% of a sum of thicknesses of the lower layer, the intermediate layer, and the upper layer.

8. The apparatus as claimed in claim 6, wherein:
the mixture density of the intermediate layer is 50% to 90% of the mixture density of the lower layer, and
the mixture density of the upper layer is 50% to 80% of the mixture density of the lower layer.

9. The apparatus as claimed in claim 6, wherein:
the lower-layer coater, the intermediate-layer coater, and the upper-layer coater are a same coater, and
the lower-layer roller, the intermediate-layer roller, and the upper-layer roller are a same roller.

10. The apparatus as claimed in claim 6, wherein the intermediate-layer coater includes a first-side intermediate-layer coater that coats the first side of the substrate with the intermediate layer, and a second-side intermediate-layer coater that coats the second side of the substrate with the intermediate layer.

11. A method of manufacturing an electrode plate of a secondary battery, the method comprising:
coating a substrate of the secondary battery with a lower layer;
rolling the lower layer, after coating;
coating an upper layer on the lower layer, after rolling; and
rolling the upper layer, after coating, such that the upper layer is rolled to a mixture density lower than a mixture density of the lower layer after rolling.

12. The method as claimed in claim 11, wherein:
a thickness of the lower layer, before rolling, is 20% to 80% of a sum of thicknesses of the lower layer and the upper layer, and
a thickness of the upper layer, before rolling, is 20% to 80% of the sum of the thicknesses of the lower layer and the upper layer.

13. The method as claimed in claim 11, wherein:
a mixture density of the lower layer, after rolling, ranges from 1.0 to 2.0 g/cc, and
a mixture density of the upper layer, after rolling, is 50% to 90% of the mixture density of the lower layer.

14. The method as claimed in claim 11, wherein:
coating of the lower layer includes a first-side lower-layer coating of a first side of the substrate with the lower layer, and a second-side lower-layer coating of a second side of the substrate with the lower layer, and
coating of the upper layer includes a first-side upper-layer coating of the first side of the substrate with the upper layer, and a second-side upper-layer coating of the second side of the substrate with the upper layer.

15. The method as claimed in claim 11, further comprising:
coating an intermediate layer on the lower layer, after rolling the lower layer and before coating the upper layer; and
rolling the intermediate layer, such that the intermediate layer is rolled to a mixture density lower than the mixture density of the lower layer.

16. The method as claimed in claim 15, wherein:
a thickness of the intermediate layer, before rolling, is 20% to 80% of a sum of thicknesses of the lower layer, the intermediate layer, and the upper layer,
the mixture density of the intermediate layer is 50% to 90% of the mixture density of the lower layer, and
the mixture density of the upper layer is 50% to 80% of the mixture density of the lower layer.

17. An electrode plate of a secondary battery, the electrode plate comprising:
a lower layer coated on a substrate; and
an upper layer coated on the lower layer, a mixture density of the upper layer being lower than a mixture density of the lower layer.

18. The electrode plate as claimed in claim 17, wherein the mixture density of the lower layer ranges from 1.0 g/cc to 2.0 g/cc, and the mixture density of the upper layer is 50% to 90% of the mixture density of the lower layer.

19. The electrode plate as claimed in claim 17, wherein:
the lower layer includes a first-side lower layer and a second-side lower layer on opposite surfaces of the substrate, respectively, and
the upper layer includes a first-side upper layer and a second-side upper layer on opposite surfaces of the substrate, respectively.

20. The electrode plate as claimed in claim 17, further comprising an intermediate layer between the lower layer and the upper layer, a mixture density of the intermediate layer being lower than the mixture density of the lower layer.
